(19) United States
(12) Patent Application Publication
(10) Pub. No.: US 2013/0278092 A1
(43) Pub. Date: Oct. 24, 2013

(54) STATOR COOLING CHANNEL TOLERANT TO LOCALIZED BLOCKAGE

(71) Applicants: Joseph Kenneth Coldwate, Roscoe, IL (US); John M. Beck, Windsor, CT (US); Debabrata Pal, Hoffman Estates, IL (US)

(72) Inventors: Joseph Kenneth Coldwate, Roscoe, IL (US); John M. Beck, Windsor, CT (US); Debabrata Pal, Hoffman Estates, IL (US)

(73) Assignee: HAMILTON SUNDSTRAND CORPORATION, Windsor Locks, CT (US)

(21) Appl. No.: 13/454,415

(22) Filed: Apr. 24, 2012

(51) Int. Cl. H02K 9/02

(52) U.S. Cl. 310/59

(57) ABSTRACT

A stator core of a motor or generator includes a stacked stator laminations that form a plurality of outwardly extending fins and a plurality of cooling channels between the fins. Each stator lamination includes a gap larger than a cooling channel. Each stator lamination is rotated relative to a previous stator lamination in the stack. The gaps of adjacent stator laminations overlap such to connect a cooling channel to adjacent cooling channels.

### BACKGROUND OF THE INVENTION

Exemplary embodiments of this invention generally relate to electrical machines and, more particularly, to a stator structure of an electrical machine for improved cooling.

A stator generates a considerable amount of heat during operation. It is important to remove this heat because overheating of the stator may reduce the life and performance of motors and generators, thereby limiting the range of applications in which they may be used. Conventional stators include a plurality of fins disposed around the outer circumference of the stator. A cooling fluid, such as air, oil, or another coolant for example, will flow through the cooling channels created between adjacent fins to remove heat from the stator through convection.

In some applications, foreign material from the environment, such as dirt and debris, will enter the stator. This foreign material may become lodged in the stator, forming a blockage in one or more of the cooling channels. The blockage impedes the flow of the cooling fluid to a portion of the stator, such that heat from that area of the stator is not efficiently removed. Occurrence of such blockages cause the temperature of the stator to rise and can ultimately lead to a failure.

### BRIEF DESCRIPTION OF THE INVENTION

According to one embodiment, a stator lamination is provided for use in a stator core including a generally circular body. The stator lamination includes a generally circular body having a plurality of teeth projecting from the body. The teeth provide a space to receive a winding. A plurality of fins outwardly project from the outer circumference of the circular body. The fins are positioned in groups of equal spacing around the outer circumference. A first fin and a second adjacent fin within a group define a cooling channel. Adjacent groups of fins are separated by a gap. The width of the gap is larger than the width of the cooling channel.

According to one embodiment, a stator core of a motor or generator is provided including a stacked stator laminations that form a plurality of outwardly extending fins and a plurality of cooling channels between the fins. Each stator lamination includes a gap larger than a cooling channel. Each stator lamination or group of laminations is rotated relative to a previous stator lamination or group of laminations in the stack. The gaps of adjacent stator laminations overlap such to connect a cooling channel to adjacent cooling channels.

According to yet another embodiment of the invention, a stator core for use in a motor or generator is provided including a plurality of stacked stator laminations that form a plurality of outwardly extending fins and a plurality of cooling channels between the fins. A portion of at least one fin is removed so that adjacent cooling channels are connected.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front view of a stator lamination according to an embodiment of the invention;

FIG. 2 is a top view of a stator core according to an embodiment of the invention; and

FIG. 3 is a perspective view of a stator core according to an embodiment of the invention.

The detailed description explains embodiments of the invention, together with advantages and features, by way of example with reference to the drawings.

### DETAILED DESCRIPTION OF THE INVENTION

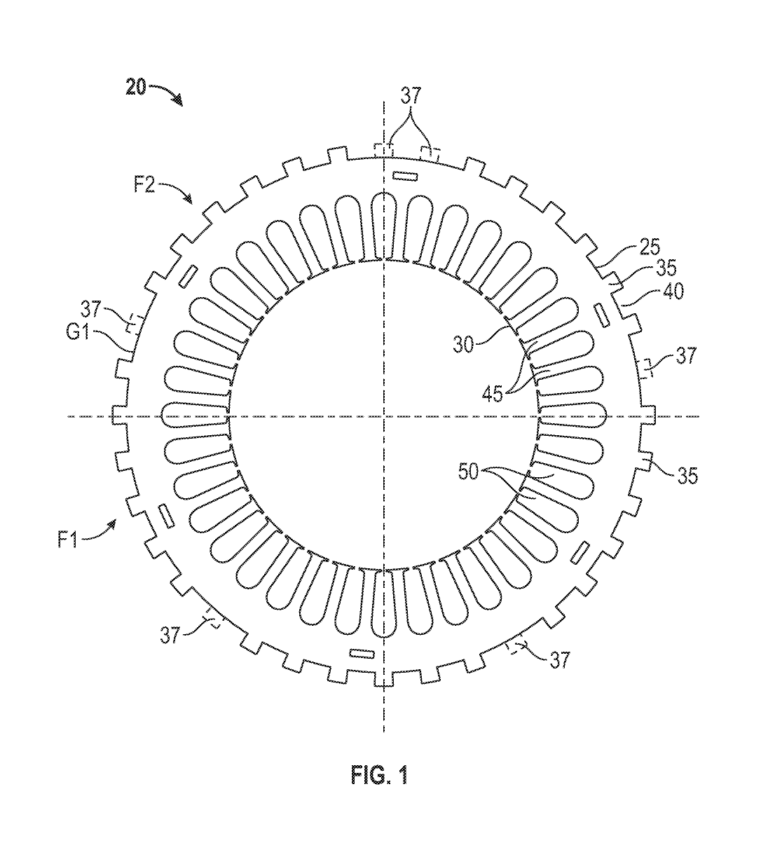

Referring now to FIG. 1, a generally circular stator lamination 20 is illustrated. The stator lamination 20 may be made from iron or any other conventionally used material. The stator lamination 20 includes a plurality of outwardly projecting fins 35, located around the outer circumference 25 thereof. The fins 35 define an outer periphery of a stator. In one embodiment, the fins 35 are uniform in size. A plurality of cooling channels 40 are created between adjacent fins 35 such that a cooling fluid (not shown) may flow through the cooling channels 40 to remove heat from the stator lamination 20. The stator lamination 20 additionally includes a plurality of inwardly projecting teeth 45 that define the inner periphery of a stator. The teeth 45 also provide winding spaces 50 that receive the windings (not shown) of the stator.

In one embodiment, the stator lamination 20 fins 35 are positioned around the outer circumference 25 in groups of equally spaced fins 35 and cooling channels 40. Adjacent groups of fins 35, such as groups F1 and F2 for example, are separated by a gap, such as G1 for example. The gaps G separating adjacent groups F of fins 35 have a width greater than the width of the cooling channels 40 created by the equally spaced fins 35 with the group F. The gaps G between adjacent groups F of equally spaced fins 35 may be uniform in size, or alternately, may vary in size.

In another embodiment, the fins 35 are equally spaced around the outer circumference 25 of the stator lamination 20. At least one fin 35 is then removed from the outer circumference 25 of the stator laminator 20. Removing a fin 35 connects the cooling channels 40 that were located on each side of the removed fin 35, thereby forming a gap G. In one embodiment, the width of gap G is comparable to the width of two cooling channels and the width of a fin 35. Exemplary removed fins are illustrated by gray dotted lines and are given reference numeral 37 for descriptive purposes. Fins 35 may be removed at an equal spacing around the circumference 25 of the stator laminator 20, such as every seventh fin 35 for example. In one embodiment, six fins 35 are removed from a stator lamination 20 originally having thirty six fins 35. Additional fins 35 may be removed to create more gaps, or larger gaps G, as necessary based upon the application.

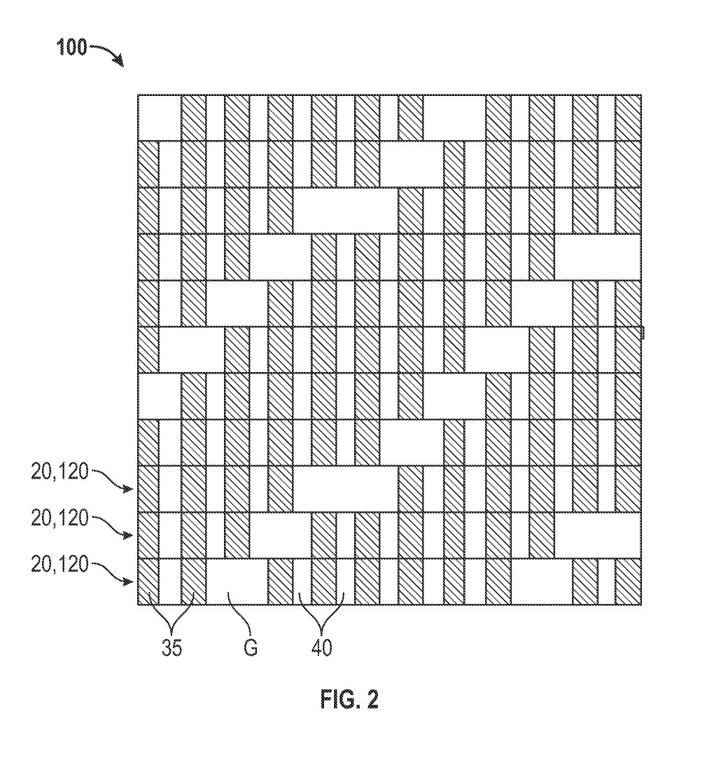

Referring now to FIG. 2, an exemplary stator core 100 for use in a motor or generator is illustrated. The stator core 100 is formed by stacking multiple stator laminations 20. The plurality of stator laminations 20 used to create the stator core 100 may be identical and manufactured using the same tool, such as a stamping die for example. In one embodiment, the stator laminations 20 are arranged into groups 120, such as groups of ten for example. Groups 120 of stator laminations 20 are then stacked to form a stator core 100. If the stator laminations 20 are arranged into groups 120, the fins 35, cooling channels 40, removed fins, and gaps G of each stator lamination 20 are aligned such that each group 120 resembles a stator lamination 20 having a certain depth.

In one embodiment each adjacent stator lamination 20 is rotated relative to an adjacent stator lamination 20 or alternatively, adjacent groups 120 of stator laminations 20 are rotated relative to one another. Each stator lamination 20 or group 120 of stator laminations 20 is rotated such that a gap G overlaps a portion of the gap G of the previous stator lamination 20 or group 120 of stator laminations 20. The stator lamination 20 or group 120 of stator laminations 20 is also rotated such that the majority of the fins 35 are aligned with the fins 35 of the previous stator lamination 20, or group 120 of stator laminations 20, to form fins 35 and cooling channels 40 that extend along the depth of the stator core 100. In one embodiment, stator laminations 20, or groups 120 of stator laminations 20, are rotated sixty degrees relative to the previously stacked stator lamination 20, or group 120 of stator laminations 20 respectively. By rotating each stator lamination 20 or group 120 of stator laminations 20, adjacent cooling channels 40 are connected by the overlapping gap G. In one embodiment, all of the cooling channels 40 are connected. Thus, if a blockage occurs and prevents the flow of a cooling fluid through a portion of a cooling channel 40, the cooling fluid will divert to the adjacent cooling channels 40, and heat will still be removed from that portion of the stator core 100.

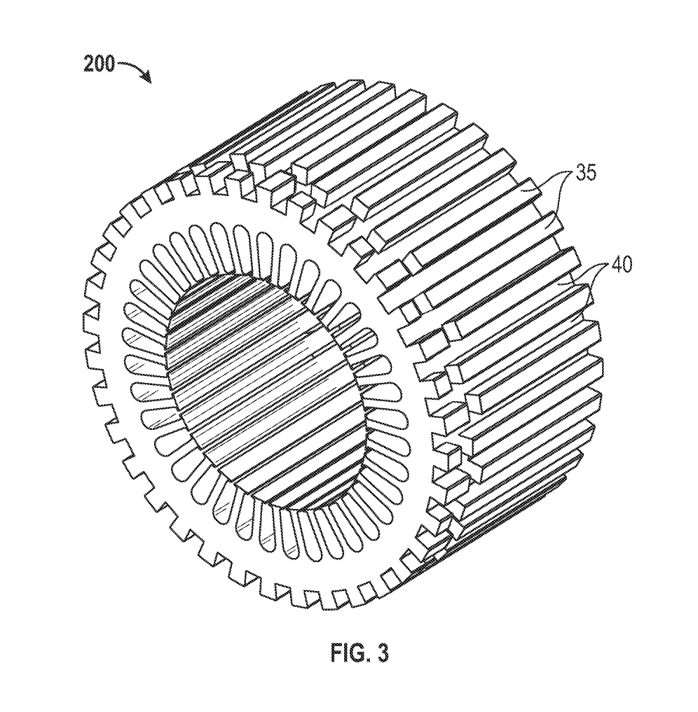

FIG. 3 illustrates a stator core 200 in accordance with another embodiment. Stator core 200 is similarly formed by stacking multiple stator laminations 20. In one embodiment, the stator laminations 20 used to form the stator core 200 do not include any gaps G and have fins 35 equally spaced around the outer circumference 25 of the lamination 20. The stator laminations 20 may be arranged so that the fins 35 and cooling channels 40 are aligned to form a stator core 200 having a uniform cross-section along the depth of the stator core 200. In one embodiment, after the stator laminations 20 have been stacked, a portion of at least one fin 35 of the stator core 200 is removed, such as by milling for example. In another embodiment, a portion of all of the fins 35 of the stator core 200 is removed.

The portions removed from the fins 35 may be equal or alternately may vary in size. The openings to join the channels can be formed orthogonal to the walls of the cooling channel or formed at an angle to enhance flow characteristics. Additionally, the portion removed may be located at the same position for each fin 35, or at varying positions along the depth of the stator core 200. In one embodiment, the portion removed from adjacent fins 35 is not located at the same position along the depth of the stator core 200. The portion of the fin 35 that is removed may alternate between a first position and a second position along the depth of the stator core 200. For example, a first fin may have a portion removed at a first location, a second adjacent fin may have a portion removed at a second location, a third fin adjacent the second fin may have a portion removed at a first location and so on around the outer circumference 25 of the stator core 200. By removing a portion of the fins 35, adjacent cooling channels 40 are connected such that if a blockage exists in a cooling channel 40, the cooling fluid will flow to the adjacent cooling channels 40 to remove heat from that portion of the stator core 200.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A stator lamination comprising:
a generally circular body;
a plurality of teeth projecting inwardly from the body that provide a space to receive a winding;
a plurality of fins projecting outwardly from the circular body and positioned in groups of equal spacing around an outer circumference of the circular body; wherein a cooling channel is defined between a first fin and a second adjacent fin within a group; and wherein adjacent groups of fins are separated by a gap having a width larger than a width of the cooling channel.

2. The stator lamination according to claim 1, wherein the gaps between the adjacent groups are created by removing an equally spaced fin from around the circumference such that the cooling channels adjacent the removed fin are connected.

3. The stator lamination according to claim 1, wherein the stator lamination includes five gaps generally equally spaced around the outer circumference.

4. The stator lamination according to claim 1, wherein the plurality of fins is uniform in size and the plurality of cooling channels is uniform in size.

5. The stator lamination according to claim 1, wherein the stator lamination is formed by a stamping operation.

6. A stator core for use in a motor or generator comprising:
a plurality of stacked stator laminations forming a plurality of outwardly extending fins and a plurality of cooling channels positioned between the fins;
wherein each stator lamination includes at least one gap larger than a cooling channel; and
wherein each stator lamination is rotated relative to a previous stator lamination in the stack, such that a gap of a first stator lamination overlaps a gap of a second, previous stator lamination, thereby connecting a cooling channel to adjacent cooling channels.

7. The stator core according to claim 6, wherein the stator laminations are formed into groups of aligned stator laminations, and adjacent groups are rotated relative to one another.

8. The stator core according to claim 7, wherein each group includes ten stator laminations.

9. The stator core according to claim 6, wherein each stator lamination is rotated sixty degrees.

10. The stator core according to claim 6, wherein each all of the cooling channels of the stator core are connected.

11. The stator core according to claim 6, wherein the stacked stator laminations are identical.

12. A stator core comprising:
a plurality of stacked stator laminations rotated relative to one another and each including a plurality of outwardly extending fins and a plurality of cooling channels positioned between the fins;
wherein a portion of at least one fin is removed such that adjacent cooling channels are connected.

13. The stator core according to claim 12, wherein the portion of the fin is removed by milling.

14. The stator core according to claim 12, wherein a portion of each of the fins of the stator core is removed.

15. The stator core according to claim 12, wherein the portion removed from a first fin is at a first position and the portion removed from a second, adjacent fin is at a second position.

16. The stator core according to claim 12, wherein the portion removed from adjacent fins alternates between a first position and a second position.

17. The stator core according to claim 12, wherein all of the cooling channels of are connected.
